(19) United States
(12) Patent Application Publication
(10) Pub. No.: US 2023/0284701 A1
(43) Pub. Date: Sep. 14, 2023

(54) VAPOR-GENERATION DEVICE AND SUSCEPTOR FOR VAPOR-GENERATION DEVICE

(71) Applicant: SHENZHEN FIRST UNION TECHNOLOGY CO., LTD., Shenzhen City, Guangdong Province (CN)

(72) Inventors: ZEXIN WU, Shenzhen City, Guangdong Province (CN); ZUQIANG QI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/008,159

(22) PCT Filed: Jun. 2, 2021
(86) PCT No.: PCT/CN2021/097995

§ 371 Date: Dec. 2, 2022

(30) Foreign Application Priority Data
Jun. 2, 2020 (CN) 202020984699.0
Jan. 27, 2021 (CN) 202120224124.3

(51) Int. Cl. A24F 40/465; H05B 6/10; A24F 40/51; A24F 40/57

(52) U.S. Cl. CPC A24F 40/465; A24F 40/51; A24F 40/57; H05B 6/108

(57) ABSTRACT

An aerosol generating device and a susceptor (30, 30a). The susceptor (30, 30a) comprises a susceptive portion (31a, 32a) as well as a first metal material (33a) and a second metal material (34a) that are connected to the susceptive portion (31a, 32a), the first metal material (33a) and the second metal material (34a) are different materials, and thus a thermocouple for sensing the temperature of the susceptive portion is formed between the first metal material (33a) and the second metal material (34a). The susceptor (30, 30a) is provided with different thermocouple materials by means of welding, etc. to form a thermocouple that can be used for measuring the temperature of the susceptor (30, 30a) by means of the thermoelectric potential, thereby accurately measuring the temperature of the susceptor (30, 30a) while heating a puffable material in response to the magnetic field. Compared with temperature measurement methods using temperature sensors, the present application is more convenient in production and can achieve more accurate temperature measurement effect.

### CROSS REFERENCE TO RELATED APPLICATIONS

This application claims priority to Chinese Patent Application No. 202020984699.0, filed with the Chinese Patent Office on Jun. 02, 2020 and entitled “SUSCEPTOR FOR VAPOR-GENERATION DEVICE, AND VAPOR-GENERATION DEVICE”, which is incorporated herein by reference in its entirety.

This application claims priority to Chinese Patent Application No. 202120224124.3, filed with the Chinese Patent Office on Jan. 27, 2021 and entitled “HEATING ASSEMBLY AND AEROSOL-GENERATION DEVICE”, which is incorporated herein by reference in its entirety.

### TECHNICAL FIELD

Embodiments of this application relate to the field of heat-not-burn cigarette devices of an electromagnetic induction type, and in particular, to a vapor-generation device and a susceptor for a vapor-generation device.

### BACKGROUND

Tobacco products (such as cigarettes and cigars) burn tobaccos during use to produce tobacco smoke. People attempt to make products that release compounds without burning to replace these tobacco-burning products.

An example of products of this type are a heating device that releases compounds by heating materials rather than burning the materials, for example, the materials may be tobaccos or other non-tobacco products that may or may not contain nicotine. In a known device, temperature monitoring is required in a process of heating a tobacco product; The example of the products of this type is attached to a heating component through a temperature susceptor, to obtain a temperature of the heating component.

### SUMMARY

To resolve a problem of temperature monitoring of a tobacco product heating device in the related art, embodiments of this application provide a vapor-generation device of an electromagnetic induction type and a susceptor for a vapor-generation device which are convenient for manufacturing and accurate temperature detection.

This application provides a vapor-generation device, configured to heat an inhalable material to generate an aerosol, and including:
a chamber, configured to receive at least one part of the inhalable material;
a magnetic field generator, configured to generate a variable magnetic field; and
a susceptor, including a sensing part, and a first metal material and a second metal material that are connected to the sensing part, where
the sensing part is configured to be penetrated by the variable magnetic field to generate heat, to heat the inhalable material received in the chamber; and
the first metal material and the second metal material are made of different materials, to cause a thermocouple used for sensing a temperature of the sensing part to be formed between the first metal material and the second metal material.

In a preferred implementation, the first metal material and/or the second metal material are constructed as elongated filaments.

In a preferred implementation, the sensing part includes:
a first part and a second part, where
the second part is constructed as a tube extending along an axis direction of the chamber;
the first part includes a lengthened portion extending in the second part; and the first metal material and/or the second metal material are basically accommodated in the second part, and are connected to the lengthened portion.

In a preferred implementation, the second part includes a first end and a second end that are opposite each other along a length direction, where at least one part of the first part penetrates the second part through the first end and forms the lengthened portion; and

a distance from a connecting position between the first metal material and/or the second metal material and the lengthened portion to the first end along the length direction of the second part is in one third to one second of a length size of the second part.

In a preferred implementation, the lengthened portion abuts against an inner wall of the second part to conduct heat with each other.

In a preferred implementation, a radian of the lengthened portion along a circumferential direction of the second part is less than π.

In a preferred implementation, an outer diameter of at least one part of the first part exposed outside the first end decreases gradually along a direction facing away from the second part.

In a preferred implementation, the susceptor further includes a base part arranged on the second end of the second part, and the vapor-generation device provides support for the susceptor through the base part.

In a preferred implementation, both the first metal material and the second metal material are constructed as being connected to one of the first part and the second part;

or one of the first metal material and the second metal material is connected to the first part, and the other is connected to the second part.

In a preferred implementation, surfaces of the first metal material and/or the second metal material are covered by an insulating layer.

In a preferred implementation, at least one accommodation channel extending substantially along a length direction of the susceptor is arranged inside the susceptor, and a volume of a hollow part formed in the at least one accommodation channel is less than 25% of a volume of the susceptor; and

both the first metal material and the second metal material are at least partially received in the accommodation channel.

In a preferred implementation, the accommodation channel includes one hole, and the first metal material and the second metal material are simultaneously arranged in one hole;

or the accommodation channel includes two holes, and the first metal material and the second metal material are respectively arranged in one hole.

In a preferred implementation, when the accommodation channel includes two holes, a diameter of the susceptor is 2 to 2.6 mm, and diameters of the holes are 0.5 to 0.7 mm.

In a preferred implementation, the susceptor has a first end and a second end that face away from each other along the length direction; and

the accommodation channel starts from the first end of the susceptor, extends substantially toward the second end, and ends at a closed end, and the closed end is located between the first end and the second end.

In a preferred implementation, an extension length of the accommodation channel is 30% to 80% of an extension length of the susceptor.

In a preferred implementation, the susceptor includes a first heating section and a second heating section that are fixedly connected.

In a preferred implementation, a through hole is arranged on the first heating section along the length direction to form the accommodation channel.

In a preferred implementation, both the first metal material and the second metal material include a connection portion and an extending portion;

the connection portion is tightly close to a connecting position between the first heating section and the second heating section to be fixed; and the extending portion is at least partially arranged in the accommodation channel.

In a preferred implementation, a groove is arranged on an end surface on which the first heating section is connected to the second heating section, and the connection portion is fixed in the groove.

In a preferred implementation, when the connection portion is fixed in the groove, the connection portion is lower than or flush with the end surface on which the groove is located.

In a preferred implementation, the device further includes a filling body, where the filling body is filled in the groove in which the connection portion is fixed.

In a preferred implementation, the groove comes into communication with the accommodation channel.

In a preferred implementation, the volume of the hollow part formed in the at least one accommodation channel is within 20% of the volume of the susceptor.

This application further provides a susceptor for a vapor-generation device, including:
a sensing part, and a first metal material and a second metal material that are connected to different positions of the sensing part, where
the sensing part is capable of being penetrated by a variable magnetic field to generate heat; and the first metal material and the second metal material are made of different materials, to cause a thermocouple used for sensing a temperature of the sensing part to be formed between the first metal material and the second metal material.

In the above susceptor for a vapor-generation device, galvanic couple materials made of different materials are arranged on the susceptor by welding or the like, so that a thermocouple that can be used for detecting a temperature of the susceptor through a thermal electromotive force is formed, which can accurately detect the temperature of the susceptor while heating an inhalable material in response to a magnetic field. The temperature detection manner of the susceptor is more convenient in manufacturing and has a more accurate temperature detection effect compared with that of a temperature sensor.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic structural diagram of a vapor-generation device according to Embodiment 1;

FIG. 2 is a schematic structural diagram of a susceptor according to a preferred embodiment in Embodiment 1;

FIG. 3 is a schematic exploded view of various parts of the susceptor shown in FIG. 2 before assembly;

FIG. 4 is a schematic cross-sectional structural view of the susceptor shown in FIG. 2 along a radial direction;

FIG. 5 is a schematic cross-sectional structural view of a susceptor according to yet another embodiment in Embodiment 1;

FIG. 6 is a schematic structural diagram of a susceptor according to yet another embodiment in Embodiment 1;

FIG. 7 is a schematic structural diagram of a heating assembly according to Embodiment 2;

FIG. 8 is a cross-sectional view of FIG. 7;

FIG. 9 is a cross-sectional view of yet another embodiment in Embodiment 2;

FIG. 10 is a schematic structural diagram of a heating body according to yet another embodiment in Embodiment 2;

FIG. 11 is a schematic structural diagram of a heating assembly according to yet another embodiment in Embodiment 2;

FIG. 12 is a schematic structural diagram of a heating assembly according to yet another embodiment in Embodiment 2;

FIG. 13 is a schematic structural diagram of a heating body according to yet another embodiment in Embodiment 2;

FIG. 14 is a temperature diagram of a sample A; and

FIG. 15 is a temperature diagram of a sample B.

### DETAILED DESCRIPTION

To make the foregoing objects, features and advantages of this application more comprehensible, detailed description is made to specific implementations of this application below with reference to the accompanying drawings. In the following description, many specific details are described to give a full understanding of this application. However, this application may be implemented in many other manners different from those described herein. A person skilled in the art may make similar improvements without departing from the connotation of this application. Therefore, this application is not limited to the specific implementations disclosed below.

It should be noted that, when a component is referred to as “being fixed to” another component, the component may be directly on the other component, or an intervening component may be present. When a component is considered to be “connected to” another component, the component may be directly connected to the another component, or an intervening component may also be present.

Unless otherwise defined, meanings of all technical and scientific terms used in this specification are the same as those usually understood by a person skilled in the art to which this application belongs. In this specification, terms used in the specification of this application are merely intended to describe objectives of the specific embodiments, but are not intended to limit this application. The term “and/or” used in this specification includes any and all combinations of one or more related listed items.

### Embodiment 1

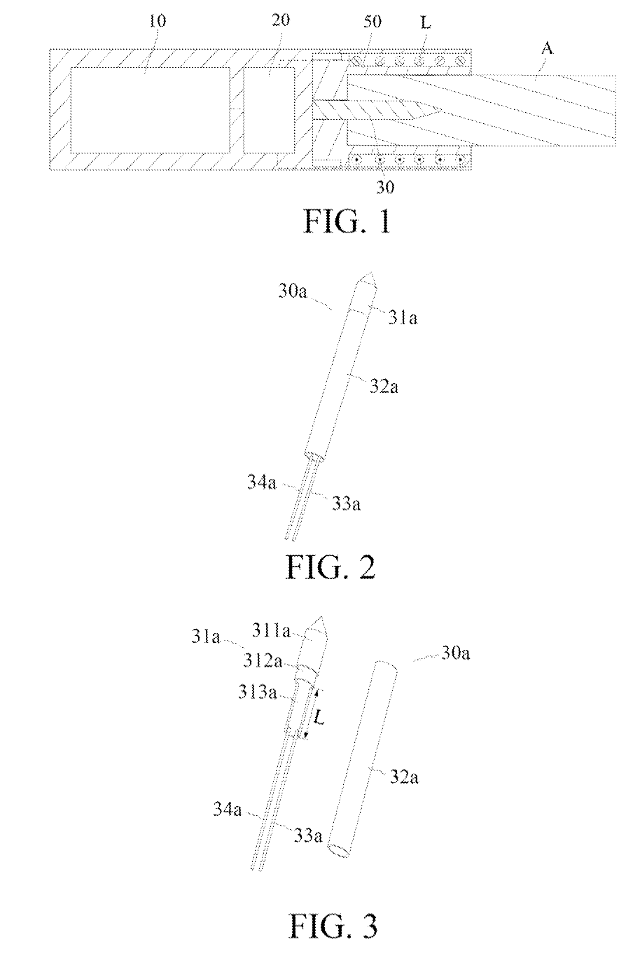

An embodiment of this application provides a vapor-generation device whose construction may refer to FIG. 1, including:
a chamber, where an inhalable material A is removably received in the chamber;
an induction coil L, configured to generate a variable magnetic field under an alternating current;
a susceptor 30, where at least one part of the susceptor extends in the chamber, and the susceptor is configured to be inductively coupled to the induction coil L, and be penetrated by the variable magnetic field to generate heat, to heat the inhalable material A such as a cigarette, so that at least one type of ingredient of the inhalable material A is evaporated, to form an aerosol for suction;
a cell 10, being a rechargeable direct current cell, and being capable of outputting a direct current; and
a circuit 20, connected to the rechargeable cell 10 through a suitable current, and configured to convert the direct current outputted by the cell 10 into an alternating current with a suitable frequency and supply the alternating current to the induction coil L.

According to the settings used in a product, the induction coil L may include a cylindrical inductor coil wound into a helical shape, as shown in FIG. 1. The cylindrical induction coil L wound into the helical shape may have a radius r whose range is approximately 5 mm to approximately 10 mm. Preferably, the radius r may be approximately 7 mm. A length of the cylindrical induction coil L wound into the helical shape may be in a range of approximately 8 mm to approximately 14 mm, and a number of turns of the induction coil L is in a range of approximately 8 turns to 15 turns. Correspondingly, an internal volume thereof may be in a range of approximately 0.15 cm³ to approximately 1.10 cm³.

In a more preferred implementation, a frequency of the alternating current supplied by the circuit 20 to the induction coil L is in a range of 80 KHz to 400 KHz. More specifically, the frequency may be in a range of approximately 200 KHz to 300 KHz.

In a preferred embodiment, a direct current supply voltage provided by the cell 10 is in a range of approximately 2.5 V to approximately 9.0 V, and an amperage of the direct current that the cell 10 can provide is in a range of approximately 2.5 A to approximately 20 A.

In a preferred embodiment, the susceptor 30 may have a length of approximately 12 mm, a width of approximately 4 mm, and a thickness of approximately 50 µm, and may be made of stainless steel of level 430 (SS430). In an alternative embodiment, the susceptor 30 may have a length of approximately 12 mm, a width of approximately 5 mm, and a thickness of approximately 50 µm, and may be made of stainless steel of level 430 (SS430). In yet another preferred embodiment, the susceptor 30 may be constructed as a cylindrical shape; and an internal space thereof during use is for receiving the inhalable material A, and generating the aerosol for suction in a manner of heating an outer periphery of the inhalable material A. These susceptors may also be made of stainless steel of level 420 (SS420) and alloy materials containing iron and nickel (such as 1J85 permalloy).

In an embodiment shown in FIG. 1, the vapor-generation device further includes a tubular support 50 configured to arrange the induction coil L and the susceptor 30, and a material of the tubular support 50 may include a non-metal material with high temperature resistance such as PEEK or ceramic. During implementations, the induction coil L is wound on an outer wall of the tubular support 50.

In a preferred implementation, to enable a heating temperature for the inhalable material A to be accurately monitored and control components in contact with the inhalable material A during mounting to have lower heat wastes, in yet another embodiment shown in FIG. 2 to FIG. 4, construction of a susceptor 30a is provided, and includes:
a sensing part formed by a first part 31a and a second part 32a, being substantially in a shape of a pin to be inserted into an inhalable material A to heat; and
a first metal material 33a and a second metal material 34a, respectively connected to different positions of the sensing part, where the first metal material 33a and the second metal material 34a are prepared by using different galvanic couple materials, to form a thermocouple that may be used for sensing a temperature of the susceptor 30a between the first metal material 33a and the second metal material 34a.

Specifically, during implementations, the first metal material 33a and the second metal material 34a are constructed as elongated filaments or in a form of pins, and may be fixedly connected to the sensing part by welding or the like. When generating heat under penetration of a variable magnetic field, the sensing part is coupled and connected to a circuit 20 through free ends of the first metal material 33a and the second metal material 34a, so that a change of an electromotive force caused by a change of the temperature of the susceptor 30a can be detected, so as to determine the temperature of the susceptor 30a.

In an optional implementation, the first metal material 33a may be made of one of nickel, nickel-chromium alloy, nickel-silicon alloy, nickelchrome-Kao copper, constantan bronze, and ferrochrome; and the second metal material 34a may be made of another one different from that of the first metal material 33a in the above materials.

During implementations, the first metal material 33a and the second metal material 34a are isolated from the variable magnetic field, to prevent the first metal material 33a and the second metal material 34a from being heated by the magnetic field into a temperature equivalent to that of the sensing part to affect realization of a temperature detection function.

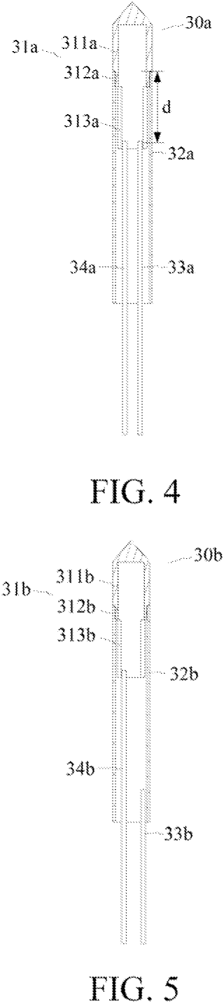

Further, according to the example shown in FIG. 3 and FIG. 4, for convenience of production and assembly of the susceptor 30a, during implementations, the sensing part is divided into a first part 31a and a second part 32a that can be independently disassembled and assembled.

In an optional implementation, the first part 31a and the second part 32a in FIG. 3 and FIG. 4 are prepared by using suitable metal or alloy sensing materials.

In yet another optional implementation, the first part 31a and the second part 32a are prepared by spraying, printing, and deposing coating layers with metal or alloy sensing materials on surfaces of rigid substrates such as ceramic and heat-resistant plastic.

Further, according to FIG. 3 and FIG. 4,
the second part 32a is constructed as a hollow cylindrical or tubular shape; and
the first part 31a includes:
   a pinhead portion 311a, where an outer diameter of at least one part of the pinhead portion 311a gradually decreases to form a conical tip, and the conical tip enables the sensing part to be smoothly inserted into the inhalable material A;
   a connection portion 312a formed by extension of the pinhead portion 311a toward the second part 32a, where the connection portion 312a is in a columnar shape whose outer diameter is smaller than a maximum outer diameter of the pinhead portion 311a, and the outer diameter of the connection portion 312a is compatible with an inner diameter of the second part 32a, so that the connection portion 312a extends into the second part 32a during mounting and enables the first part 31a to be tightly connected to an end portion of the second part 32a by interference or close fitting; and
   a lengthened portion 313a extending from the connection portion 312a, where the lengthened portion 313a is constructed as an arc shape; and the lengthened portion 313 is configured to weld the first metal material 33a and the second metal material 34a.

Meanwhile, in the preferred embodiment shown in FIG. 3, the first metal material 33a and the second metal material 34a are respectively connected to parts of the lengthened portion 313a close to two sides thereof.

In the preferred embodiment shown in FIG. 4 after assembly, the first metal material 33a and the second metal material 34a are constructed as at least partially being exposed after passing through an inner cavity of the second part 32a, so as to be coupled to the circuit 20. Moreover, during implementations, both the first metal material 33a and the second metal material 34a are located in an internal magnetic field shielded area of the tubular second part 32a, so that the first metal material 33a and the second metal material 34a does not generate heat during use, thereby preventing the first metal material 33a and the second metal material 34a from being exposed to the magnetic field for induction and generating heat to affect detection signals.

In the preferred embodiment shown in FIG. 3, an extension length L of the lengthened portion 313a is approximately a length of 5 mm, and the lengthened portion 313a is located in the magnetic field shielded area formed in the inner cavity of the tubular second part 32a. Moreover, the lengthened portion 313a abuts against and is tightly close to an inner wall of the second part 32a, so that the lengthened portion 313a can receive heat of the second part 32a. Therefore, a temperature detected through the first metal material 33a and the second metal material 34a is substantially an average temperature of the first part 31a and the second part 32a.

According to the preferred embodiment shown in FIG. 4, a size of a distance d from a connecting position between the first metal material 33a and the second metal material 34a and the lengthened portion 313a to an upper end of the second part 32a along a length direction of the second part 32a is approximately in one third to one second of a length of the second part 32a. This part is basically an area where heating temperatures of the second part 32a in the magnetic field are relatively concentrated, so that a temperature change result sensed by the susceptor 30a when the first metal material 33a and the second metal material 34a are correspondingly connected to this part is more accurate.

Based on the preferred implementation shown in FIG. 4, a shape of the lengthened portion 313a is non-cylindrical construction, but is constructed as an arc sheet. Specifically, in FIG. 4, a radian of the lengthened portion 313a along a circumferential direction of the second part 32a is less than π. Therefore, the lengthened portion 313a has a sufficiently large opening for connecting the first metal material 33a and the second metal material 34a by welding or the like.

Further, during implementations, to prevent the second part 32a with a metal material from interfering with detection, an insulating layer covering the first metal material 33a and the second metal material 34a is formed on surfaces of the first metal material 33a and the second metal material 34a in a manner of deposition, electroplating, spraying, surface oxidation, and the like, so as to be insulated from the second part 32a and other parts of the susceptor 30a.

Alternatively, in yet another optional implementation shown in FIG. 5, a first metal material 33b of a susceptor 30b is connected to a second part 32b by welding or the like, and a second metal material 34b is connected to a lengthened portion 313b of a first part 31b, to cause a thermocouple used for sensing a temperature of the susceptor 30b to be formed between the first metal material 33b and the second metal material 34b.

Alternatively, in another optional implementation, the first metal material 33b and the second metal material 34b are connected to a same position point or a same part of the susceptor 30b by welding or the like.

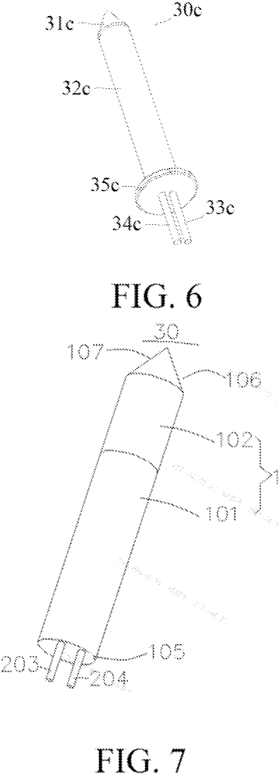

In yet another optional implementation shown in FIG. 6, a susceptor 30c may also have a base part 35c arranged at an end portion of a second part 32c, and may provide support for the base part 35c through a tubular support 50 or another component during use, so that the susceptor 30c maintains stably in a vapor-generation device.

A first metal material 33c and a second metal material 34c penetrate from the inside of the second part 32c to the outside of the base part 35c, so as to be connected to the circuit 30.

Alternatively, in yet another variant implementation different from that shown in FIG. 6, parts of the first metal material 33c and the second metal material 34c exposed to the outside of the base part 35c are constructed as shapes of electrical contacts or terminals formed on the base part 35c, so that the circuit 20 can be connected to the first metal material 33c and the second metal material 34c through suitable electrical terminals or conductive spring pins.

Meanwhile, the base part 35c is prepared by a thermally insulating PEEK material or zirconia ceramic with low thermal conductivity, which can effectively prevent heat of the susceptor 30c from being transferred to a tubular support 50 or other components.

In the above susceptor for a vapor-generation device, galvanic couple materials made of different materials are arranged on the susceptor by welding or the like, so that a thermocouple that can be used for detecting a temperature of the susceptor through a thermal electromotive force is formed, which can accurately detect the temperature of the susceptor while heating an inhalable material in response to a magnetic field. The temperature detection manner of the susceptor is more convenient in manufacturing and has a more accurate temperature detection effect compared with that of a temperature sensor.

### Embodiment 2

Based on the above Embodiment 1, this application provides the following specific embodiment, which specifically provides a specific structure of a heating body or a heating assembly and an example thereof. Specifically, the vapor-generation device described in the above Embodiment 1 is specifically an aerosol-generation device in this embodiment of this application, the susceptor 30 described in the above Embodiment 1 is specifically a heating body 1 or a heating assembly 30 in this embodiment of this application, and the metal materials (including the first metal material 33a and the second metal material 34a) described in the above Embodiment 1 are specifically thermocouple wires (a first thermocouple wire 203 and a second thermocouple wire 204) in this embodiment of this application. Specifically,

as shown in FIG. 1, the aerosol-generation device includes a housing assembly 10, a chamber 1001, and the heating assembly 30, the chamber 1001 is arranged in the housing assembly 10, and the heating assembly 30 is positioned in the chamber 1001 to heat an aerosol-forming substrate. The aerosol-generation device may further include a circuit board 20 and a controller (not drawn). The circuit board 20 is connected to the controller. The aerosol-generation device may further include a battery assembly 10, and both the circuit board 20 and the controller are electrically connected to the battery assembly 10.

As shown in FIG. 7 to FIG. 9, the heating assembly 30 includes the heating body 1 having a first end 105 and a second end 106 and extending between the first end 105 and the second end 106 and a temperature sensing unit 2, and the heating body 1 is configured to heat the aerosol-forming substrate to generate an aerosol. At least one accommodation channel 4 extending substantially along a length direction of the heating body 1 (for example, the accommodation channel 4 may be oblique and extend along the length direction of the heating body 1) is arranged inside the heating body 1, and a volume of a hollow part formed in the at least one accommodation channel 4 is less than 25% of a volume of the heating body 1 (where the volume of the accommodation channel 4 is not subtracted when the volume of the heating body 1 is calculated). The temperature sensing unit is received in the accommodation channel.

For the heating body 1 of a same material (a same specific heat capacity), a heat storage capacity is proportional to the volume of the entity. A larger accommodation channel 4 indicates a smaller volume of the entity of the heating body 1, resulting in a poorer heat storage capacity. During use of the aerosol-generation device, cold air first passes through an end (the first end) of the heating body 1, and then passes through an other end (the second end) of the heating body 1. The cold air continuously absorbs heat of the heating body 1 in a process from the first end of the heating body 1 to the second end. That is because when the air is at the first end, a temperature difference between the air and the first end of the heating body 1 is large so that more heat is absorbed, and when the air is at the second end, the air has absorbed a lot of heat in the process of flowing and the air temperature is high so that the air absorbs less heat at the second end. The heat absorbed by the air at the first end and the second end in the process of flowing is different. An accommodation channel of the existing heater body is large, a volume of an entity thereof is small, and the energy storage thereof is poor. Therefore, when heat lost at the first end is more than that at the second end, a temperature of the first end is low, while a temperature of the second end is high, so that a temperature of the entire heating body 1 is uneven. In this application, the volume of the accommodation channel 4 is controlled to be within 25% of the volume of the heating body 1, and the volume of the entity of the heating body 1 is large, thereby having a good heat storage capacity. Therefore, when the heat lost at the first end is more than that at the second end, the temperature of the first end does not fluctuate too much, so that the temperature of the first end is relatively close to the temperature of the second end, and the temperature of the entire heating needle is more even.

The temperature sensing unit 2 includes a first thermocouple wire 203 and a second thermocouple wire 204, and the first thermocouple wire 203 and the second thermocouple wire 204 are at least partially arranged in the accommodation channel.

There are at least two arrangement manners for the accommodation channel described below, which are only listed herein. This application is not limited to these two manners.

First manner (FIG. 7 and FIG. 8): the accommodation channel 4 includes two holes, and the first thermocouple wire 203 and the second thermocouple wire 204 are respectively arranged in one hole. A length of the heating body 1 is 10 to 70 mm (where a tip 107 of the heating body 1 is substantially conical, and a length thereof is 2 mm). Preferably, the length of the heating body 1 is 10 to 25 mm, a diameter of the heating body 1 is 2 to 2.6 mm, and a diameter of the hole is 0.5 to 0.7 mm. Preferably, the length of the heating body 1 is 20 mm, the diameter of the heating body 1 is 2.3 mm, and the diameter of the hole is 0.55 mm.

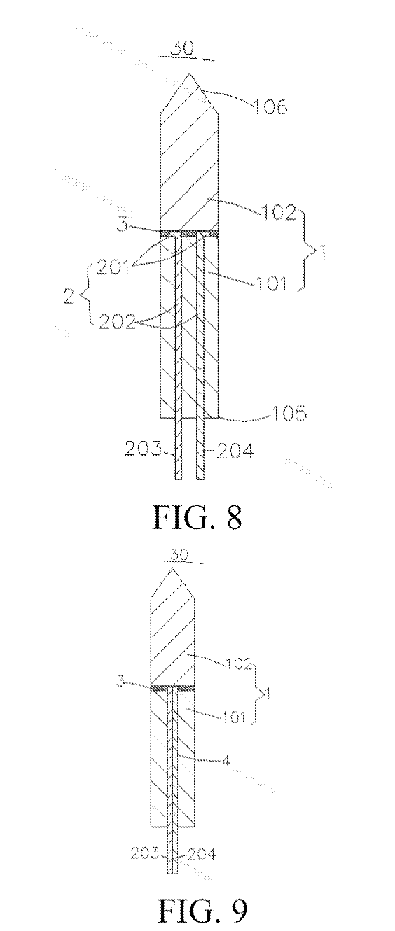

Second manner (FIG. 9): the accommodation channel 4 includes one hole, and the first thermocouple wire 203 and the second thermocouple wire 204 are simultaneously arranged in one hole.

The accommodation channel 4 starts from the first end 105 of the heating body, extends substantially toward the second end 106, and ends at a closed end, and the closed end is located between the first end 105 and the second end 106. An extension length of the accommodation channel 4 is 30% to 80% of an extension length of the heating body. Preferably, the extension length of the accommodation channel is 50% to 70% of the extension length of the heating body.

When the length of the heating body is 20 mm, the diameter of the heating body 1 is 2 mm, the accommodation channel 4 includes two holes, diameters of the holes are 0.7 mm, and depths of the holes are 14.4 mm, the volume of the hollow part formed in the accommodation channel is 18.9% of the volume of the heating body.

When the length of the heating body is 20 mm, the diameter of the heating body 1 is 2.3 mm, the accommodation channel 4 includes two holes, diameters of the holes are 0.55 mm, and depths of the holes are 12 mm, the volume of the hollow part formed in the accommodation channel is 7.4% of the volume of the heating body.

When the length of the heating body is 10 mm, the diameter of the heating body 1 is 2.6 mm, the accommodation channel 4 includes two holes, diameters of the holes are 0.5 mm, and depths of the holes are 3.4 mm, the volume of the hollow part formed in the accommodation channel is 2.9% of the volume of the heating body.

Preferably, the volume of the hollow part formed in the accommodation channel is within 20% of the volume of the heating body.

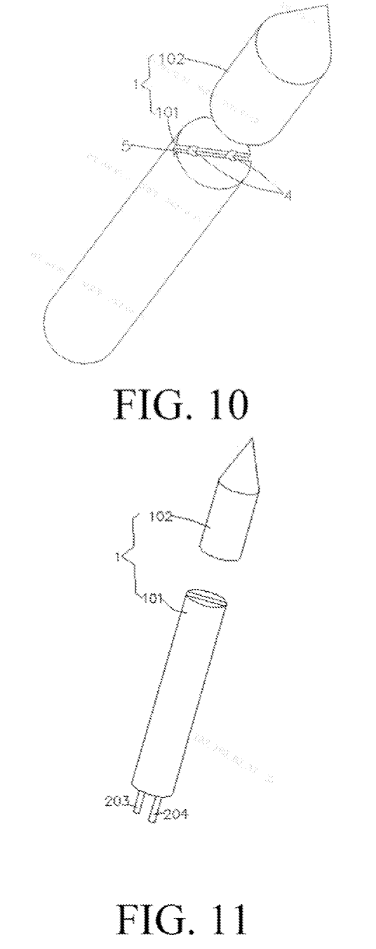

The heating body 1 is divided into a first heating section 101 and a second heating section 102 (shown in FIG. 10) in the length direction.

A through hole is arranged on the first heating section 101 along the length direction to form the accommodation channel 4 (shown in FIG. 8, FIG. 9, and FIG. 10). Both the first thermocouple wire 203 and the second thermocouple wire 204 include a connection portion 201 and an extending portion 202, and the extending portion 202 is at least partially arranged in the accommodation channel 4. The connection portion 201 is tightly close to a connecting position between the first heating section 101 and the second heating section 102 to be fixed. Specifically, a groove 5 is arranged on the heating body 1, the extending portion 202 is fixed in the groove 5, and the accommodation channel 4 comes into communication with the groove 5.

There are at least three arrangement manners for the groove 5, which are only listed herein. This application is not limited to three manners described below.

First manner (FIG. 10): the groove 5 is arranged on the first heating section 101, and is located on an end surface on which the first heating section 101 is connected to the second heating section 102.

Second manner (FIG. 9): the groove 5 is arranged on the second heating section 102, and is located on an end surface on which the second heating section 102 is connected to the first heating section 101.

Third manner: the groove 5 is arranged on the first heating section 101 and the second heating section 102, and the groove 5 is arranged on the end surface on which the first heating section 101 is connected to the second heating section 102.

In the related art, a blind hole is opened inside the heating body 1, then the temperature sensing unit 2 is inserted into the blind hole, and the temperature sensing unit 2 and the heating body 1 are not fixed, so that the contact between the temperature sensing unit 2 and the heating body 1 is unstable and the measured temperature is inaccurate. In this application, the connection portion 201 is fixedly connected to the heating body 1, so that the contact between the temperature sensing unit 2 and the heating body 1 is stable and reliable, and the measured temperature is more accurate.

When the connection portion 201 is fixed in the groove 5, the connection portion 20 is lower than or flush with the end surface on which the groove 5 is located, so that the first heating section 101 can be connected to the second heating section 102. When the connection portion 201 is fixed in the groove 5, there may also be a gap in the groove 5. In this case, a filling body 3 is used to fill the groove 5 (FIG. 11), to avoid that if there is the gap in the groove 5 after the first heating section 101 is connected to the second heating section 102, on the one hand, the volume of the entity of the heating body 1 is affected, so that the heat storage capacity of the heating body 1 is affected; and on the other hand, the gap part relies on air to conduct heat, so that the heat transfer is slow. When the filling body 3 is filled in the gap, and heat conduction of the filling body 3 is fast, so that the heating body 1 heats more evenly. The filling body 3 may be nickel welded in the groove 5.

The heating body 1 has at least two types, which are only listed herein. This application is not limited to two manners described below.

First manner (shown in FIG. 1): the heating body 1 is an electromagnetic heating body, that is, the aerosol-generation device further includes an induction coil L, configured to generate a variable magnetic field under an alternating current; and the heating body 1 is coupled to the induction coil L, so that the first heating section 101 and the second heating section 102 are penetrated by the variable magnetic field to generate heat, so as to heat an aerosol-forming substrate 40 to generate an aerosol. According to the settings used in a product, the induction coil L may include a cylindrical induction coil wound into a helical shape, as shown in FIG. 1. The cylindrical induction coil L wound into the helical shape may have a radius r whose range is approximately 5 mm to approximately 10 mm. Preferably, the radius r may be approximately 7 mm. A number of turns of the induction coil L is approximately in a range of approximately 8 turns to 15 turns. A frequency of the alternating current supported by the circuit 20 to the induction coil L is in a range of 80 KHz to 400 KHz. More specifically, the frequency may be in a range of approximately 200 KHz to 300 KHz. A direct current supply voltage provided by the battery assembly 10 is in a range of approximately 2.5 V to approximately 9.0 V, and an amperage of a direct current that the battery assembly 10 can provide is in a range of approximately 2.5 A to approximately 20 A.

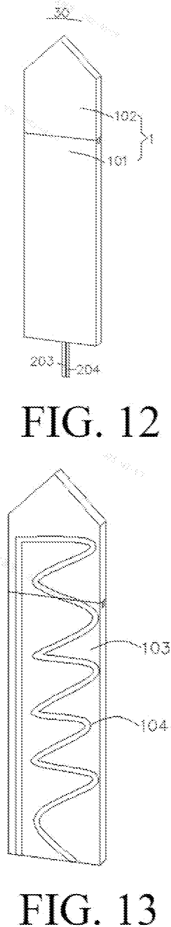

Second manner (FIG. 8 and FIG. 12): the heating body 1 is of a printed circuit type, that is, the first heating section 101 and the second heating section 102 include a base body 103 and a printed circuit 104, and the printed circuit 104 is arranged on the base body 103. The base body 103 may be made of a conductor or a non-conductor (such as ceramic or glass). If the base body 103 is made of the conductor, an insulating layer needs to be made on a surface of the base body 103 before the printed circuit 104 is printed, and then the printed circuit 104 is printed. To facilitate the printing of the printed circuit 104, the first heating section 101 and the second heating section 102 may be fixedly connected first, and then the printed circuit 104 may be printed.

Both the first heating section 101 and the second heating section 102 generate heat. Compared with a situation in which only the first heating section 101 generates heat and the second heating section 102 does not generate heat, the connection portion 201 is fixed on the end surface on which the first heating section 101 is connected to the second heating section 102, so that the temperature detected by the temperature sensing unit 2 is more accurate.

The heating assembly further includes a base 6, the base 6 is arranged on an end of the first heating section 101 away from the second heating section 102, and the arrangement of the base 6 is convenient for fixing the heating body 1 in the aerosol-generation device.

Ends of the first heating section 101 and the second heating section 102 that are close to each other are chamfered during processing, and there may be a circle of connecting grooves (not shown in the figure) after the first heating section 101 and the second heating section 102 are fixedly connected. To prevent the connection grooves from collecting dirt, the connection grooves may be filled with nickel wires to keep an outer surface of the heating body 1 smooth.

To study an influence of a proportion of the volume of the accommodation channel 4 to the volume of the heating body 1 on the heating body 1, the applicant has done the following set of experiments:

Sample A: the diameter of the heating body 1 is 2.3 mm, the first heating section 101 is 12.3 mm long and is solid, the second heating section 102 is 6 mm long, two through holes form the accommodation channel 4, diameters of the through holes are 0.55 mm, the volume of the accommodation channel 4 is 8.3% of the volume of the heating body 1 (where the volume of the accommodation channel 4 is not subtracted when the volume of the heating body 1 is calculated), a groove 5 is arranged on an end of the first heating section 101 close to the second heating section 102, and both a width and a depth of the groove 5 are 0.4 mm. The first thermocouple wire 203 and the second thermocouple wire 204 with the insulating layer removed at both ends pass through the two through holes respectively, and then are welded in the groove 5. Then, the first heating section 101 and the second heating section 102 are welded. On an outer surface of the heating body 1, starting from an end of the second heating section 102 away from the first heating section 101, in the length direction, one thermocouple is welded every 2 mm, and a total of 5 thermocouples are welded (where a first thermocouple is welded at 3 mm from an end surface).

Sample B: the sample B and the sample A have same other arrangements, a difference therebetween is that one through hole forms the accommodation channel 4, and a diameter of the through hole is 1.6 mm (where the volume of the accommodation channel 4 accounts for 35% of the volume of the heating body 1).

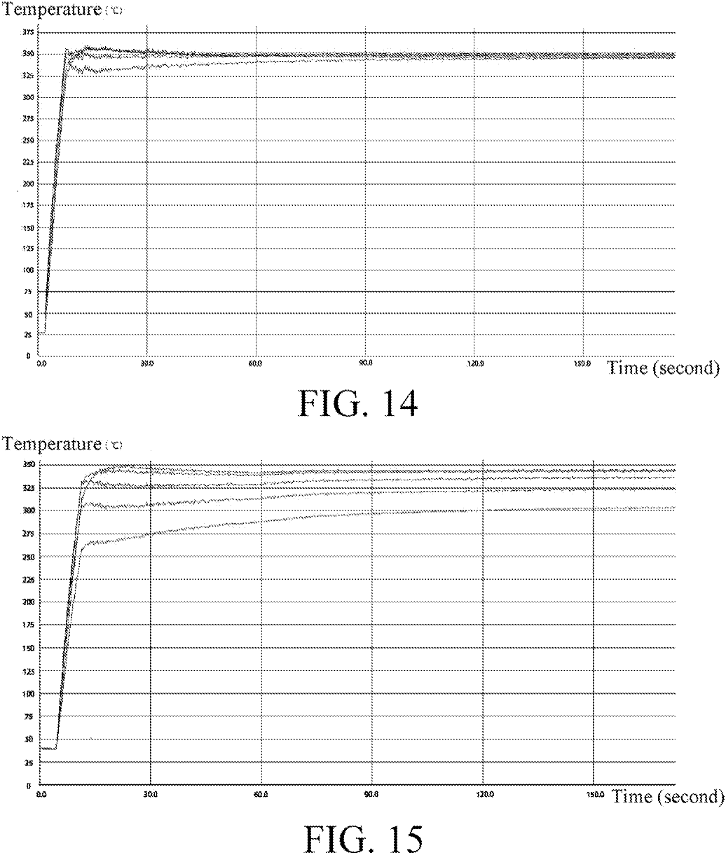

The sample A and the sample B are put in an alternating magnetic field, the sample A and the sample B generate heat, and temperatures detected by the five thermocouples of the sample A and the sample B are recorded respectively. The temperatures recorded by the sample A are shown in FIG. 14, and the temperatures recorded by the sample B are shown in FIG. 15. It can be seen from FIG. 14 that temperature lines detected by the five thermocouples are very close to each other and even overlap, temperature differences of the five detection points are within 10° C., so that the overall heating of the heating body 1 is even. As shown in FIG. 15, temperature lines detected by the five thermocouples have large gaps, and temperature differences detected by the five thermocouples are about 40° C., and temperature differences between sections of the heating body 1 are large. In summary, the proportion of the volume of the accommodation channel 4 to the volume of the heating body 1 is controlled, which can effectively improve the heating uniformity of the heating body 1.

The foregoing descriptions are merely preferred embodiments of this application, but are not intended to limit this application. Any modification, equivalent replacement, or improvement made within the spirit and principle of this application shall fall within the protection scope of this application.

It should be noted that, the specification of this application and the accompanying drawings provide the preferred embodiments of this application, but are not limited to the embodiments described in this specification. Further, for those of ordinary skill in the art, improvements or transformations can be made based on the above descriptions, and all these improvements and transformations shall fall within the protection scope of the appended claims of this application.

What is claimed is:

1. A vapor-generation device, configured to heat an inhalable material to generate an aerosol, and comprising:
a chamber, configured to receive at least one part of the inhalable material;
a magnetic field generator, configured to generate a variable magnetic field; and
a susceptor, comprising a sensing part, and a first metal material and a second metal material that are connected to the sensing part, wherein:
the sensing part is configured to be penetrated by the variable magnetic field to generate heat, to heat the inhalable material received in the chamber; and
the first metal material and the second metal material are made of different materials, to cause a thermocouple used for sensing a temperature of the sensing part to be formed between the first metal material and the second metal material.

2. The vapor-generation device according to claim 1, wherein the first metal material and/or the second metal material are constructed as elongated filaments.

3. The vapor-generation device according to claim 1 or 2, wherein the sensing part comprises:
a first part and a second part, wherein:
the second part is constructed as a tube extending along an axis direction of the chamber;
the first part comprises a lengthened portion extending in the second part; and the first metal material and/or the second metal material are basically accommodated in the second part, and are connected to the lengthened portion.

4. The vapor-generation device according to claim 3, wherein the second part comprises a first end and a second end that are opposite each other along a length direction, wherein at least one part of the first part penetrates the second part through the first end and forms the lengthened portion; and
a distance from a connecting position between the first metal material and/or the second metal material and the lengthened portion to the first end along the length direction of the second part is in one third to one second of a length size of the second part.

5. The vapor-generation device according to claim 3, wherein the lengthened portion abuts against an inner wall of the second part to conduct heat with each other.

6. The vapor-generation device according to claim 3, wherein a radian of the lengthened portion along a circumferential direction of the second part is less than π.

7. The vapor-generation device according to claim 4, wherein an outer diameter of at least one part of the first part exposed outside the first end decreases gradually along a direction facing away from the second part.

8. The vapor-generation device according to claim 1 or 2, wherein the first metal material and/or the second metal material are substantially isolated from the variable magnetic field.

9. The vapor-generation device according to claim 4, wherein the susceptor further comprises a base part arranged on the second end of the second part, and the vapor-generation device provides support for the susceptor through the base part.

10. The vapor-generation device according to claim 3, wherein both the first metal material and the second metal material are constructed as being connected to one of the first part and the second part;
or one of the first metal material and the second metal material is connected to the first part, and the other is connected to the second part.

11. The vapor-generation device according to claim 1 or 2, wherein surfaces of the first metal material and/or the second metal material are covered by an insulating layer.

12. The vapor-generation device according to claim 1 or 2, wherein:
at least one accommodation channel extending substantially along a length direction of the susceptor is arranged inside the susceptor, and a volume of a hollow part formed in the at least one accommodation channel is less than 25% of a volume of the susceptor; and
both the first metal material and the second metal material are at least partially received in the accommodation channel.

13. The vapor-generation device according to claim 12, wherein the accommodation channel comprises one hole, and the first metal material and the second metal material are simultaneously arranged in one hole;
or the accommodation channel comprises two holes, and the first metal material and the second metal material are respectively arranged in one hole.

14. The vapor-generation device according to claim 13, wherein when the accommodation channel comprises two holes, a diameter of the susceptor is 2 to 2.6 mm, and diameters of the holes are 0.5 to 0.7 mm.

15. The vapor-generation device according to claim 12, wherein the susceptor has a first end and a second end that face away from each other along the length direction; and
the accommodation channel starts from the first end of the susceptor, extends substantially toward the second end, and ends at a closed end, and the closed end is located between the first end and the second end.

16. The vapor-generation device according to claim 15, wherein an extension length of the accommodation channel is 30% to 80% of an extension length of the susceptor.

17. The vapor-generation device according to claim 12, wherein the susceptor comprises a first heating section and a second heating section that are fixedly connected.

18. The vapor-generation device according to claim 17, wherein a through hole is arranged on the first heating section along the length direction to form the accommodation channel.

19. The vapor-generation device according to claim 18, wherein both the first metal material and the second metal material comprise a connection portion and an extending portion;
the connection portion is tightly close to a connecting position between the first heating section and the second heating section to be fixed; and the extending portion is at least partially arranged in the accommodation channel.

20. The vapor-generation device according to claim 19, wherein a groove is arranged on an end surface on which the first heating section is connected to the second heating section, and the connection portion is fixed in the groove.

21. The vapor-generation device according to claim 20, wherein when the connection portion is fixed in the groove, the connection portion is lower than or flush with the end surface on which the groove is located.

22. The vapor-generation device according to claim 21, further comprising a filling body, wherein the filling body is filled in the groove in which the connection portion is fixed.

23. The vapor-generation device according to claim 20, wherein the groove comes into communication with the accommodation channel.

24. The vapor-generation device according to claim 12, wherein the volume of the hollow part formed in the at least one accommodation channel is within 20% of the volume of the susceptor.

25. A susceptor for a vapor-generation device, comprising:
a sensing part, and a first metal material and a second metal material that are connected to the sensing part, wherein:
the sensing part is capable of being penetrated by a variable magnetic field to generate heat; and the first metal material and the second metal material are made of different materials, to cause a thermocouple used for sensing a temperature of the sensing part to be formed between the first metal material and the second metal material.
